(19) United States
(12) Patent Application Publication
(10) Pub. No.: US 2003/0221312 A1
(43) Pub. Date: Dec. 4, 2003

(54) PCB auto-unloading mechanism

(75) Inventor: Tzai-Wei Lee, Pa-Ter (TW)

Correspondence Address: BRUCE H. TROXELL, Suite 1404, 5205 Leesburg Pike, Falls Church, VA, 22041, US

(73) Assignee: Ta Liang Technology Co., Ltd.

(21) Appl. No.: 10/157,916

(22) Filed: May 31, 2002

(51) Int. Cl. B23P 19/00

(52) U.S. Cl. 29/762; 29/760

(57) ABSTRACT

The invention is related to a kind of a PCB unloading mechanism, consisting of a floating plate and a moving mechanism attached between a fixing plate and a bed. On both sides of the floating plate insets a bushing, allowing the floating plate to move on a guiding shaft fixed between the fixing plate and the bed. The floating plate moves up and down through the control of the moving mechanism fixed on top of the fixing plate. Moreover, a plurality of ejecting pins are embedded on the surface of the floating plate. The ejecting pins can pass through the corresponding holes on the bed and the template for displacement, allowing the PCB to be released from the fixedness and complete the unloading operation smoothly so as to ensure the accuracy of the positioning for the next processed PCB.

### FIELD OF THE INVENTION

The present invention is related to a kind of a PCB Auto-unloading mechanism, consisting of a floating plate and a moving mechanism attached between a fixing plate and a bed. On both sides of the floating plate insets a bushing, allowing the floating plate to move on a guiding shaft fixed between the fixing plate and the bed. The floating plate moves up and down through the control of the moving mechanism fixed on top of the fixing plate. Moreover, a plurality of ejecting pins are embedded on the surface of the floating plate. The ejecting pins can pass through the corresponding holes on the bed and the template for displacement, allowing the PCB to be released from the fixedness and complete the unloading operation smoothly so as to ensure the accuracy of the positioning for the next processed PCB.

### BACKGROUND OF THE INVENTION

As shown in FIG. 1, the PCB unloading mechanism of the prior art characterizes with a fixed template 2′ on the bed 1′. Positioning pins 3′ designed for the positioning of the PCB to be processed are attached on the template 2′. When the processing is done, the operator uses a shovel 5 to dig out the PCB to complete the Auto-unloading operation. However, this unloading pattern of the PCB 4′ idles the operation of the machine during the reclaiming. Moreover, digging up the PCB 4′ with a shovel 5′ would loosen up or tilt the positioning pins 3′, which influences the positioning accuracy of the next PCB 4′ and causes defective products. How to speed up the loading/unloading process of the PCB to enhance the operation of the machine and maintain the accuracy of PCB's production have always been the bottleneck of the PCB industry. This invention offers an excellent answer.

### SUMMARY OF THE INVENTION

The present invention aims at providing a kind of PBC auto-unloading mechanism by moving the floating plate up and down through the movement of the moving mechanism, by which to release the PCB from fixedness and complete the loading and unloading operations smoothly. The present invention improves the PCB unloading method of the prior art that digs off the PCB with a shovel, and enhances the operation of the machine as well as maintains the accuracy of the positioning by keeping the floating plate at a fixed vertical height, which in turn ensures the accuracy for positioning of the next PCB.

### BRIEF DESCRIPTION OF THE DRAWINGS

FIG. 1 is a traditional operation illustration of unloading the PCB with a shovel.

FIG. 2 is a structural illustration for the components of the present invention.

FIG. 3 is a movement illustration with the crank-link mechanism installed horizontally as the moving mechanism of the present invention.

FIG. 4 is a movement illustration with the cone and wedge-shaped moving mechanism installed horizontally as the moving mechanism of the present invention

FIG. 5 is a movement illustration with the wheel-moving mechanism installed horizontally as the moving mechanism of the present invention

FIG. 6 is an unloading operation illustration for the present invention. FIG. 7 is another structural illustration with other relative components of the present invention. FIG. 8 is an unloading operation illustration for another structure of the present invention.

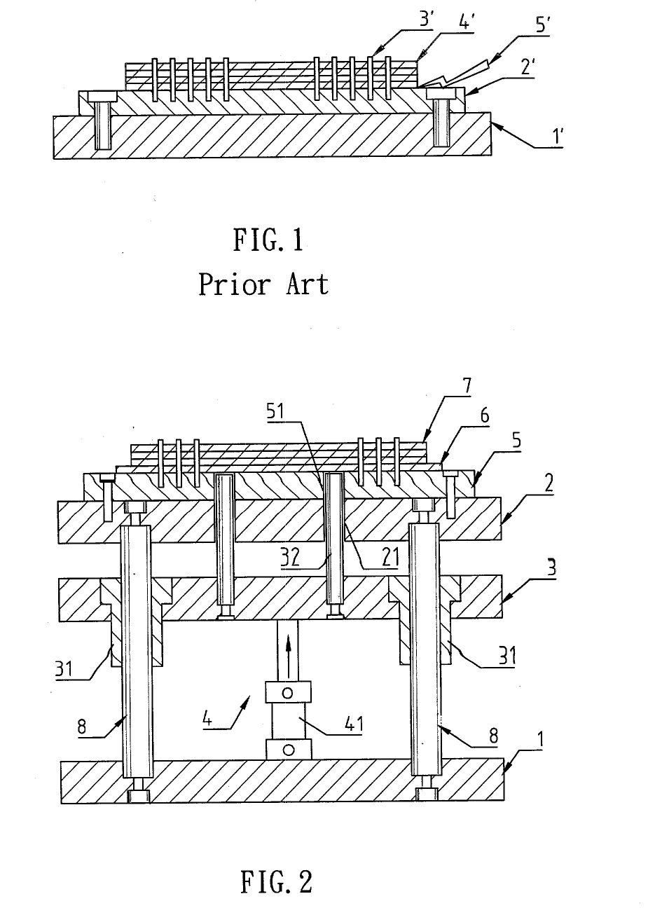

### DETAILED DESCRIPTION OF THE INVENTION

The present invention of PCB unloading mechanism is composed of the fixing plate 1 and the bed 2 equipped with one floating plate 3 and one moving mechanism 4. On both sides of the floating plate 3 embed with the bushing 31 for the floating plate 3 to move when being equipped on the guiding shaft 8 between the fixing plate 1 and the bed 2. The floating plate 3 can move vertically through the control of the moving mechanism 4 installed above the fixing plate 1.

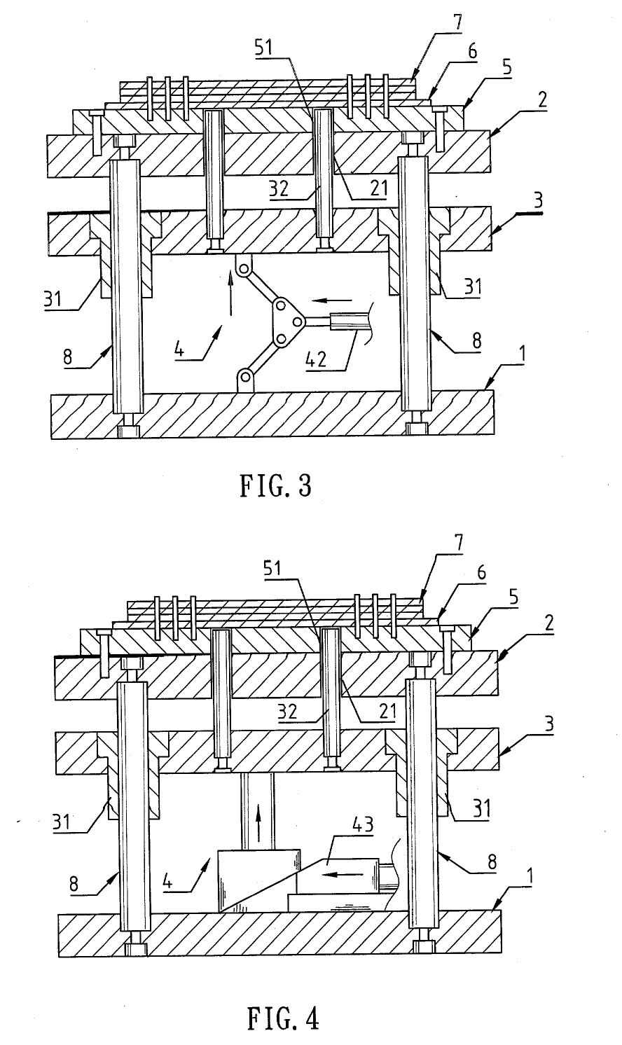

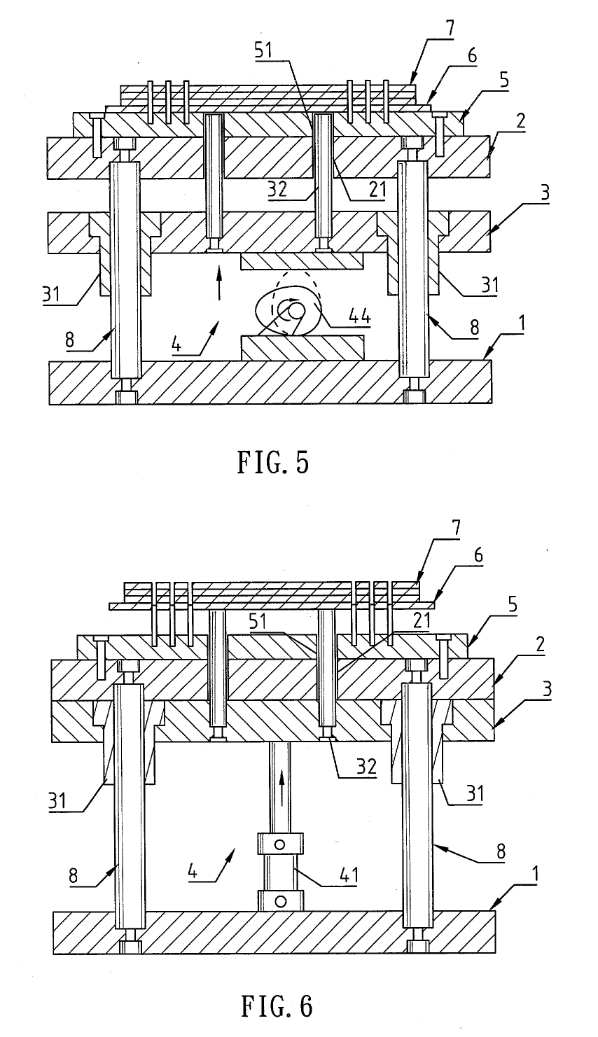

The foregoing moving mechanism 4 is a mechanism that controls the vertical movement, which can be replace with the pneumatic mechanism 41 in FIG. 2, the crank-link mechanism 12 in FIG. 3, the cone and wedge-shaped moving mechanism 13 in FIG. 4 or the wheel-moving mechanism 14 in FIG. 5 on the basis of their space requirement for installation. For example, the pneumatic mechanism 41 that belongs to a vertically installed moving mechanism 4 needs more installation space, while the crank-link mechanism 42, the cone and wedge-shaped moving mechanism 43 and the wheel-moving mechanism 44 that belong to horizontally installed moving mechanism 4 save more installation space.

Furthermore, the forgoing floating plate 1 can inset several pairs of ejecting pins 32 that pass through the holes 21, 51 on the bed 2 and the template 5. In this way, the ejecting pins 32 can prop up the template 5 with the stripper plate 6 inset with the positioning pins 52 lying above. Above the stripper plate 6, the PCB 7 to be processed is placed and fixed with the positioning pins 52 on the template 5 for processing.

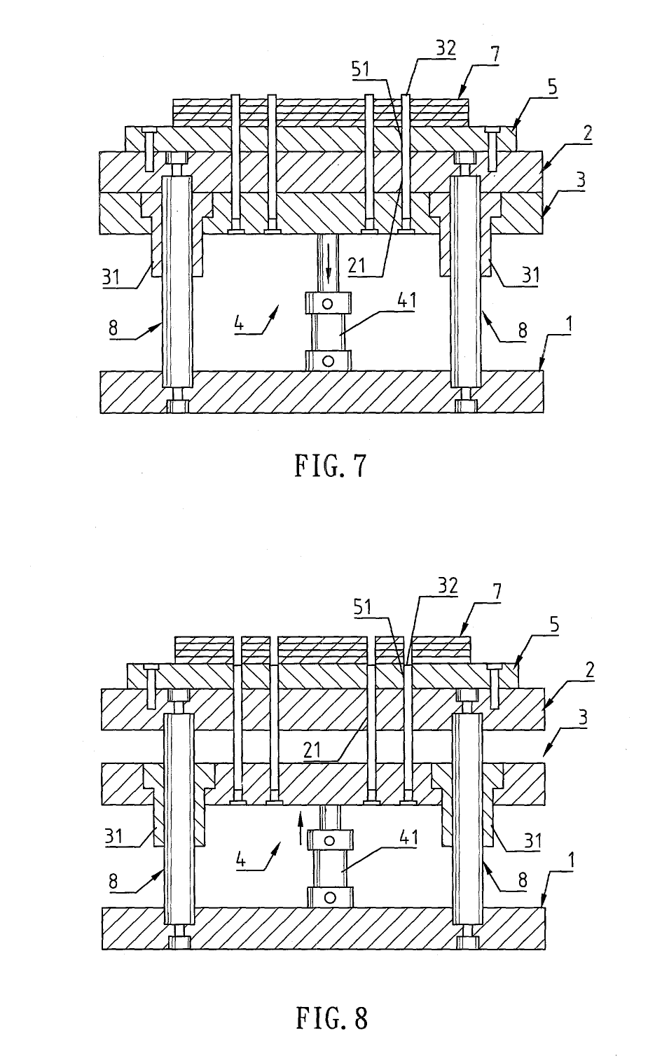

As shown in FIG. 6, the floating plate 3 of the present invention moves up and down by the movement of the moving mechanism 4. During the loading process, the moving mechanism 4 draws the floating plate 3 downward and draws the ejecting pins 32 back to the holes 21, 51 so that the PCB 7 and the stripper plate 6 lay flatly on the template 5 for processing. After processing, the moving mechanism 4 pushes the floating plate 3 upward, protruding the ejecting pins 32 over the hole 51, raising up the stripper plate 6, and then lifts up the PCB 7 to release it from the fixedness caused by the positioning pins 52. This completes the unloading operation of the PCB 7. Such invention improves the traditional unloading method of the PCB 7, which is completed with a shovel. The present invention not only enhances the operation of the machine, but also ensures the accuracy of positioning by moving the floating plate 3 horizontally with the assistance of the bushing 31 inset on both sides that keeps the ejecting pins 32 in accurate vertical displacement. By keeping the positioning pins 52 on the template 5 from slanting due to collision, the accuracy of the positioning for the next PCB 7 is ensured.

In order to simplify the parts, the positioning pins 52 on the template 5 of the PCB unloading mechanism for the present invention can replaced with the ejecting pins 32, which provide the same function as the positioning pins 52 does and discard the use of the stripper plate 6. As shown in FIG. 7 and FIG. 8, the floating plate 3 moves up and down through the movement of the moving mechanism 4. During the loading process, the movement of the moving mechanism 4 pushes the floating plate 3 upward, allowing the ejecting pins 32 to protrude the hole 51 and let the PCB 7 lay flatly on the template 5 for processing. After processing, the moving mechanism 4 is pulled downward to draw the floating plate 3 downward and draw the ejecting pins 32 back to the holes 21, 51, which then releases the PCB 7 from the fixedness caused by the ejecting pins 32 and completes the unloading operation. The simplified structure not only performs the same function, but also saves the cost of equipment.

What is claimed is:

1. A PCB unloading mechanism consisting of a fixing plate and a bed, and a floating plate and a moving mechanism equipped between said fixing plate and said bed, characterized in that:
on both sides of said floating plate, a bushing is inset for said floating plate to slide up and down when being attached to guiding shaft between said fixing plate and said bed, and said floating plate slides up and down vertically through the moving mechanism fixed above said fixing plate, furthermore, several pairs of ejecting pins are embedded above said floating plate and pass through holes on said bed and a template for displacement;
in this way, vertical movement of said floating plate resulted from said moving mechanism being pushed releases a PCB from fixedness and completes unloading operation as well as ensures accuracy of positioning for a next PCB to be processed.

2. The PCB unloading mechanism of claim 1, wherein said moving mechanism can be replaced with a pneumatic mechanism, a crank-link mechanism, a cone and wedge-shaped moving mechanism or a wheel-moving mechanism in accordance with an installation space required to control up-and-down movement.

3. The PCB unloading mechanism of claim 1, wherein said ejecting pins of said floating plate through said template prop up a stripper plate with positioning pins passing through, said PCB to be processed can be loaded above said stripper plate and then fixed by said positioning pins for processing, after processing, said moving mechanism is pushed to move said floating plate, protruding said ejecting pins over said holes and ejecting up said stripper plate, which in turn props up a PCB and then completes said unloading operation.

4. The PCB unloading mechanism of claim 1, wherein said positioning pins of said template can be replaced by said ejecting pins of said floating plate to fix a PCB and discards use of fixing components of said stripper plate, pushing said moving mechanism moves said floating plate up and down, by pushing said moving mechanism upward to move said floating plate upward that prompts said ejecting pins to protrude said holes, which in turn allows a PCB lying flatly on said template for processing, after processing, pull said moving mechanism downward to draw said ejecting pins of said floating plate back to said holes, by which releases a PCB from fixedness and completes said unloading operation.
